(19) United States
(12) Patent Application Publication
(10) Pub. No.: US 2009/0095874 A1
(43) Pub. Date: Apr. 16, 2009

(54) Cantilevered releasable locking mechanism

(76) Inventor: Phillip Young, Monterey Park, CA (US)

Correspondence Address: Frederick Gotha, Suite 823, 80 South Lake Avenue, Pasadena, CA, 91101, US

(21) Appl. No.: 11/974,235

(22) Filed: Oct. 12, 2007

(51) Int. Cl. A47B 21/04; F16M 13/00

(52) U.S. Cl. 248/575; 16/230; 248/583

(57) ABSTRACT

The invention relates to a cantilever releasable lock mechanism for selectively adjusting the height of a support platform with respect to a reference level and to adjust the angular attitude of the support platform. The mechanism consists of a housing, a carriage member having a first end and a second end where the first end is pivotally attached to the housing, a spreader member that may be axially displaced with respect to the carriage member bi-axially depending upon the direction of rotation of a support platform that is pivotally attached to the carriage member at its second end. Displacement of the spreader member in one direction urges a clutch member to apply bearing stress that locks the carriage member rotationally to the housing and in the other direction relieves the bearing stress and unlocks the mechanism.

### FIELD OF THE INVENTION

This invention relates to a cantilevered releasable locking mechanism for selectively changing the height level of a support for a computer keyboard to a desired position.

### BACKGROUND OF THE INVENTION

The extended use of the computer in the home and workplace has generated a need for reducing the physical discomfort and stress associated with misalignments of chair heights, monitor placements, mouse location, and keyboard positioning. Chair height and keyboard positioning particularly are major factors that contribute to stress and fatigue experienced after prolonged use. Although most chairs can be adjusted to minimize stress and fatigue, a more ergonomic approach would include the positioning of the keyboard to a selected comfort level with respect to the desk or table top supporting the monitor. Cantilever type mechanisms having a support platform for the keyboard where the platform can be adjusted to a selected height with respect to the desk or table top exist in the prior art but slight adjustments to the selected height along with angular positioning of the platform are cumbersome due to the gravitational locking required in the devices. It is therefore desirable to have a locking mechanism which can be easily engaged or disengaged independent of a gravitational type lock to vertically adjust the height of the keyboard and to control the desired attitude of the keyboard.

### SUMMARY OF THE INVENTION

There is therefore, provided according to the present invention, a cantilever linkage device for selectively adjusting the height and angular orientation of a support platform with respect to a desk, table top, or other reference surface. The linkage device utilizes a spreader member that may be axially displaced in one direction to activate a clutch member to lock the device and axially displaced in the opposite direction to unlock the device for re-positioning with respect to a reference surface.

The present invention is directed to a releasable locking mechanism for changing the height and angular relationship of a support platform with respect to a reference surface that consists of a u-shaped housing having a longitudinal axis and an axially extending void region therethrough that may be slidably attached to the reference surface and extend cantileverly therefrom. A u-shaped carriage member having a first and second end, where the first end extends at least in part into the housing, is pivotally carried by the housing in a frictional bearing relationship at the first end such that upon sufficient lateral bearing stress, applied at the first end of the carriage member, the housing and carriage member will be in locked rotational relationship. The mechanism by which the lateral bearing stress may be releasably applied to lock and unlock the housing and carriage member in rotational relationship and selectively position the second end of the carriage member with respect to the reference surface, includes a spreader pin that is carried by the housing and extends laterally through the void region and through the first end of the carriage member.

The carriage member has an arcuate slot that is so constructed and adapted to permit the passage of the spreader pin through the slot such that the carriage member may pivot with respect to the housing. The releasable bearing stress to lock and unlock the housing and carriage member is applied to the first end of the carriage member by a clutch member that is carried in slidable and telescopic relationship with the spreader pin. An axially displaceable spreader member having an axially extending second slot through which the spreader pin extends is carried in slidable frictional relationship with the carriage member. Thus, the carriage member and spreader member may pivot with respect to the housing while the spreader member may also be displaced axially with respect to the spreader pin. A linkage means associated with the spreader member and clutch member responsive to axial displacement of the spreader member urges the clutch member info releasable bearing engagement with the carriage member.

To axially displace the spreader member, a second spreader pin is carried by the spreader member and extends through it; the second spreader pin is located adjacent the second end of the carriage member and mounted substantially parallel to the first spreader pin.

A locking pin substantially parallel to the second spreader pin is carried by the carriage member adjacent its second end, and a support platform is pivotally carried by the second spreader pin. The support platform has an open arcuate groove with a closed thrust end and is so constructed and adapted such that the locking pin extends laterally through the groove to permit the support platform to pivot with respect to the carriage member; sufficient pivoting of the support platform results in axial displacement of the spreader member which urges the clutch member to releasably apply a lateral bearing stress to the carriage member to lock and unlock the carriage member in rotational relationship with the housing. The locking pin is in slidable relationship with the open arcuate groove which permits the support platform upon application of an external force to it to rotate with respect to the second spreader pin until the locking pin engages the closed thrust end of the arcuate groove. Upon continued application of the external force, rotation will thereafter occur about the locking pin thereby translating the rotation into axial displacement of the spreader member. A translation member mounted to the second spreader pin and to the locking pin and positioned intermediate the spreader member and support platform permits the spreader member to be axially retracted thereby releasing the clutch member from bearing engagement with the carriage; the release unlocks the housing and the carriage member and permits the carriage member to be selectively positioned with respect to the housing.

### BRIEF DESCRIPTION OF THE DRAWINGS

These and other features and advantages will become appreciated as the same become better understood with reference to the following specification, claims and drawings wherein:

FIG. 1 is a perspective view of this invention illustrating the initiation of placing the housing and carriage member in locked rotational relationship.

FIG. 2 is a perspective view of this invention illustrating the housing and carriage member in locked rotational relationship.

FIG. 3 is a prospective view of this invention illustrating the first end of the carriage member in locked relationship with the housing and a spreader member.

FIG. 4 is a bottom view of the first end of the carriage member illustrating the axial displacement of the spreader member and lateral bearing stress applied by the clutch member.

FIG. 5 is a broken bottom view of the first end of the carriage member illustrating the lock and unlock positions of the clutch member.

FIG. 6 is a perspective view of this invention illustrating the initiation of unlocking the housing and carriage member.

FIG. 7 is a perspective view of this invention illustrating the housing and carriage member in unlocked relationship.

### DETAILED DESCRIPTION

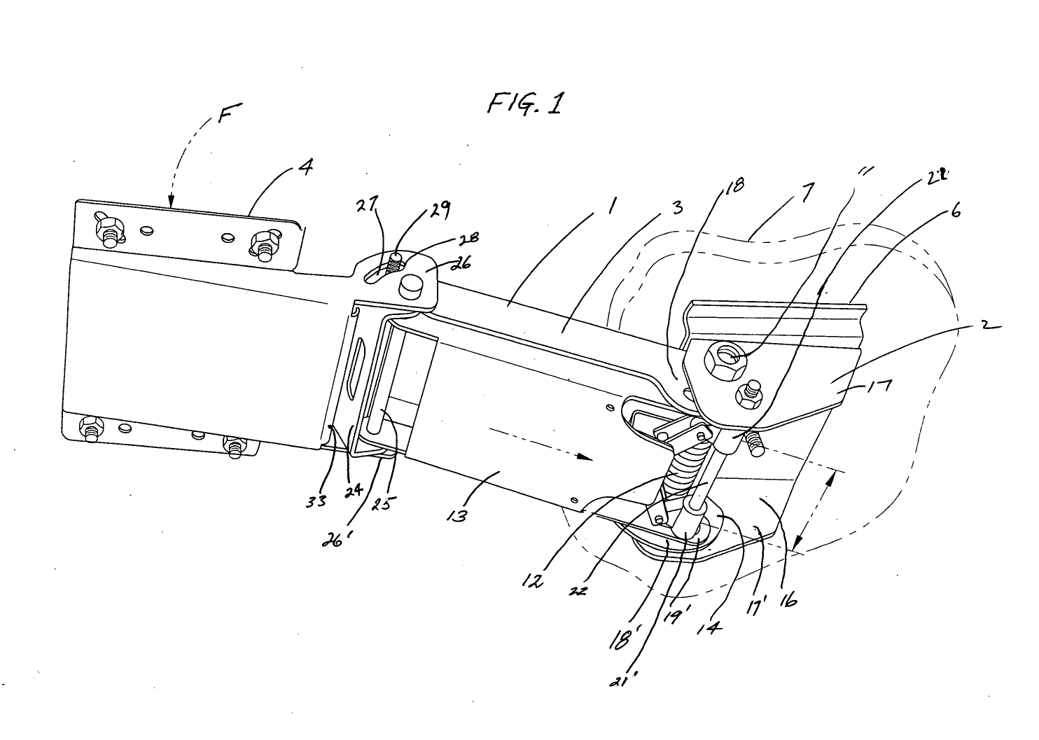

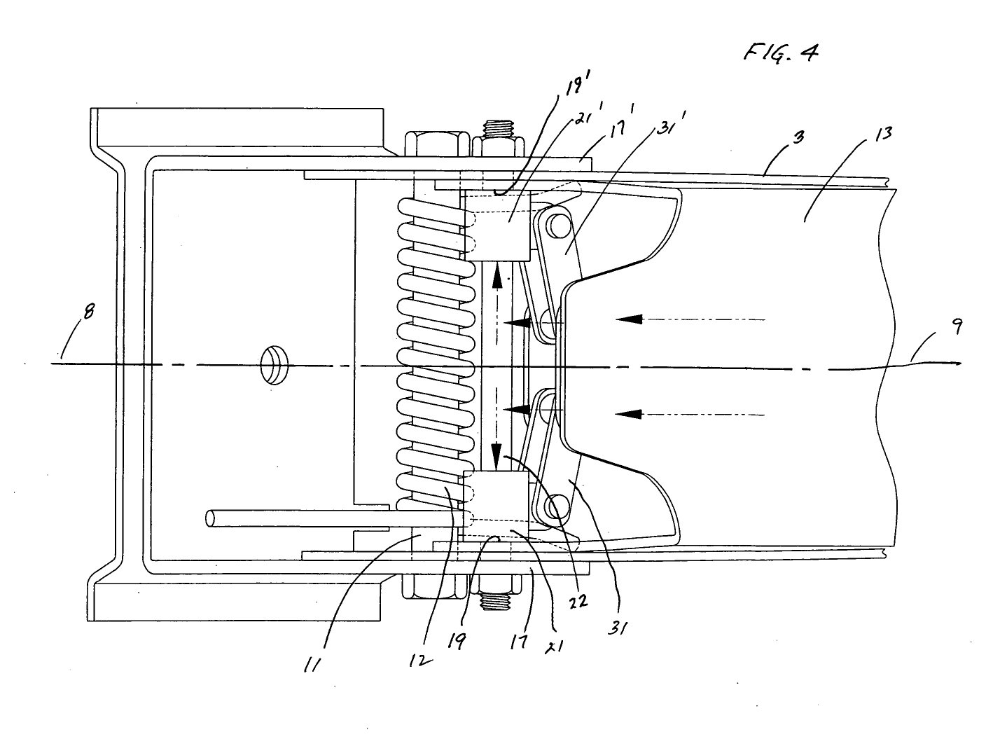

FIG. 1 illustrates in perspective the cantilever adjustable lock mechanism 1 of this invention where the rotational lock of housing 2 to carriage member 3 is under initiation by application of the force F to support platform 4. As can be seen in FIG. 1, housing 2 has a rail portion 6 for slidable engagement with a track (not shown) which is fixed to the underside of a desk or reference support member 7 (shown in phantom) By referring to FIG. 4, it can be seen that housing 2 has a longitudinal axis 8 that is coincident with axis of elongation 9 of the cantilever adjustable lock mechanism 1. Pivoting of carriage member 3 with respect to housing 2 occurs about pivot pin 11 and helical spring 12 biases carriage member 3 with respect to the housing to urge carriage member 3 into an essentially equilibrium horizontal position upon displacement therefrom.

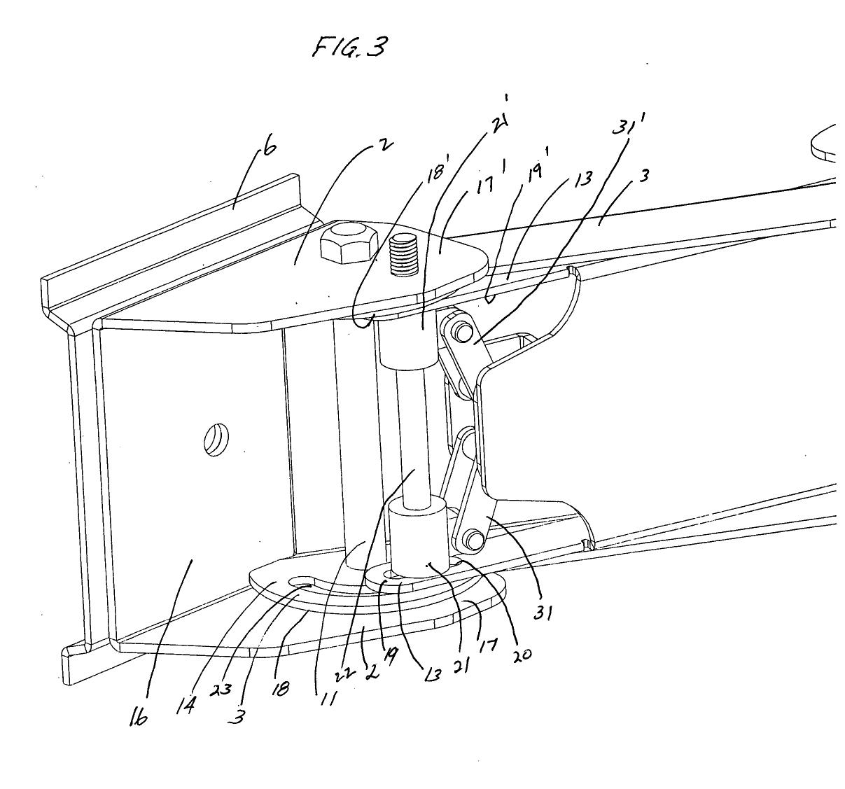

The locking features of this invention are more clearly illustrated in FIG. 3 which shows the frictional bearing relationship between housing 2, carriage member 3, and spreader member 13 at the first end 14 of the carriage member 3. As can be seen in FIG. 3, housing 2 is u-shaped and has an axially extending void 16. Carriage member 3 is also unshaped where its first end 14 extends at least in part into housing void 16. Housing void 16 is bounded by flanges 17 and 17¹ which provide the frictional surface interengagement with the flanged ends 18 and 18¹ of the first end of carriage member 3. It can also be seen in FIG. 3, that spreader member 13 has flanged ends 19 and 19¹ that frictionally engage carriage flanges 18 and 18¹; consequently, a sufficient bearing stress applied laterally to flanged ends 19 and 19¹ of the spreader member will rotationally lock the housing, carriage member and spreader member together. When the lateral bearing stress is sufficiently relieved, the respective elements will be rotationally unlocked thereby permitting the carriage member to pivot with respect to the housing. The releasable lateral bearing stress is applied through clutch members 21 and 21¹ which are slidably and telescopically carried by spreader pin 22.

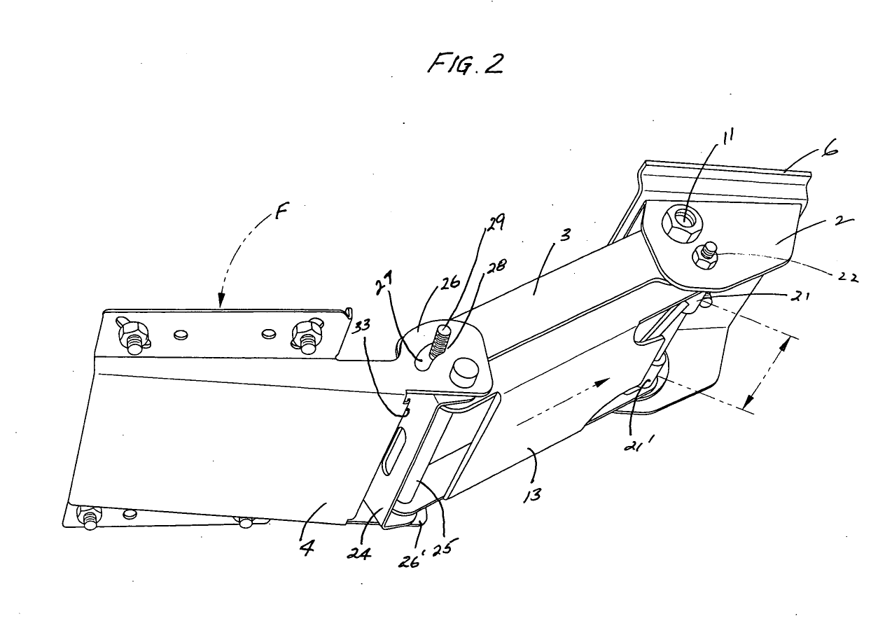

Referring again to FIG. 3, it can be seen that the flanged ends 18 and 18¹ are so constructed to permit rotation of carriage member 3 with respect to housing 2 and spreader member 13 by arcuate slots 23 and 23¹ which are contained in said flanges at the first end of carriage member 3. Spreader pin 22 extends laterally through void 16 of the housing and passes through axial slots 20 and 21¹ and arcuate slots 23 and 23¹ in slidable association with the arcuate slots and axial slots 20 and 21¹; thus, rotation of the carriage member 3 can occur with respect to the housing 2 and spreader pin 22. The mechanism by which clutch members 21 and 21¹ may apply releasable bearing stress to lock the housing and carriage member in locked rotational relationship will now be described by referring to FIGS. 2, 3, 4 and 5.

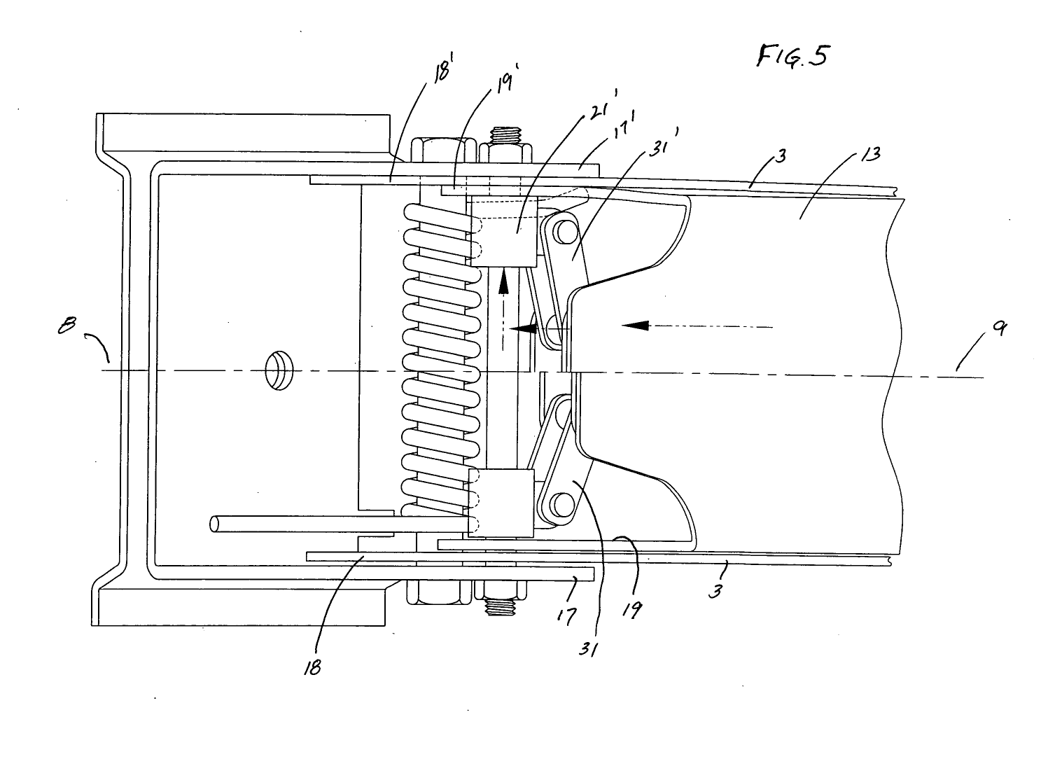

Support platform 4 is pivotally attached to spreader member 13 by second spreader pin 25 which extends laterally through translation member 24 and platform flanges 26 and 26¹. Platform flanges 26 and 26¹ have open arcuate grooves 27 and 27¹ which have barrier ends 28 and 28¹. To axially displace spreader member 13, locking pin 29 which is carried by carriage member 3 extends laterally through and in slidable relationship with arcuate groves 27 and 27¹. Thus, the continued application of external force F after locking pin 29 engages barrier ends 28 and 28¹ will result in a torque about locking pin 29 and an axial force applied to spreader member 13 (as can be seen in FIG. 2) which will cause spreader member 13 to be axially displaced with respect to carriage member 3. As can be seen in FIGS. 4 and 5, the axial displacement of spreader member 13 with respect to carriage member 3 results in hinge members 31 and 31¹, which are pivotally attached to spreader member 13 and clutch members 21 and 21¹, to translate the axial displacement into a lateral bearing stress applied by the clutch members to flanged ends 19 and 19¹.

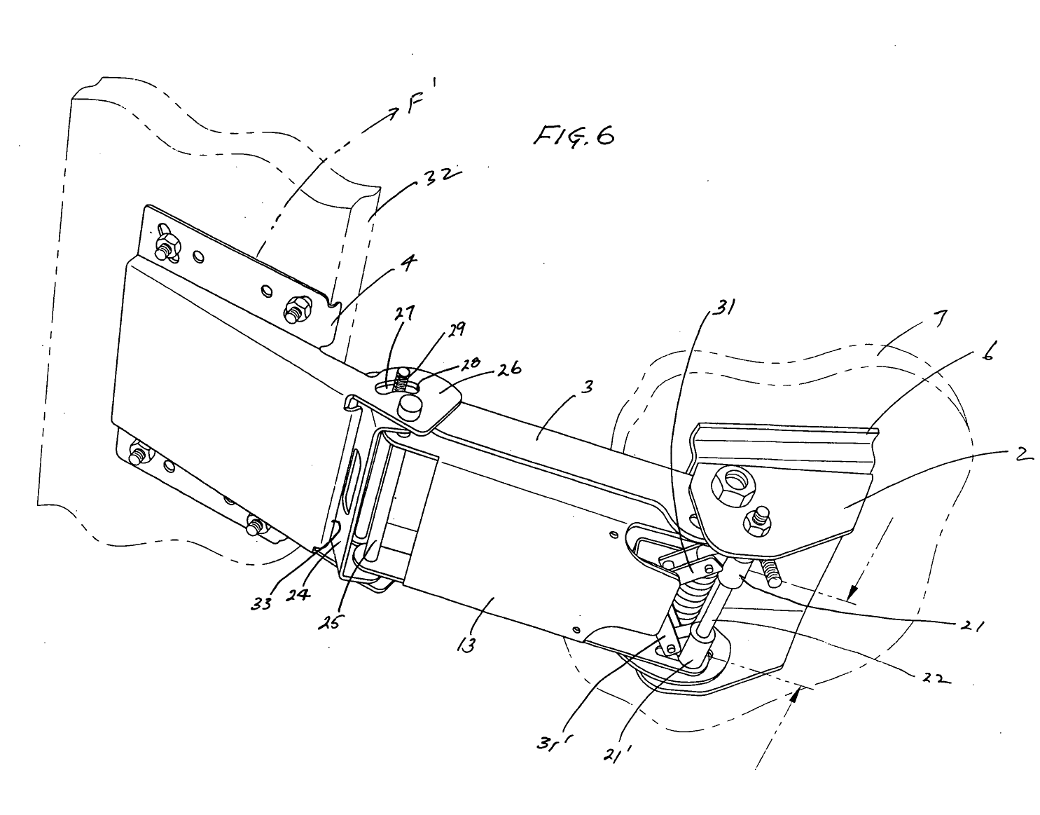

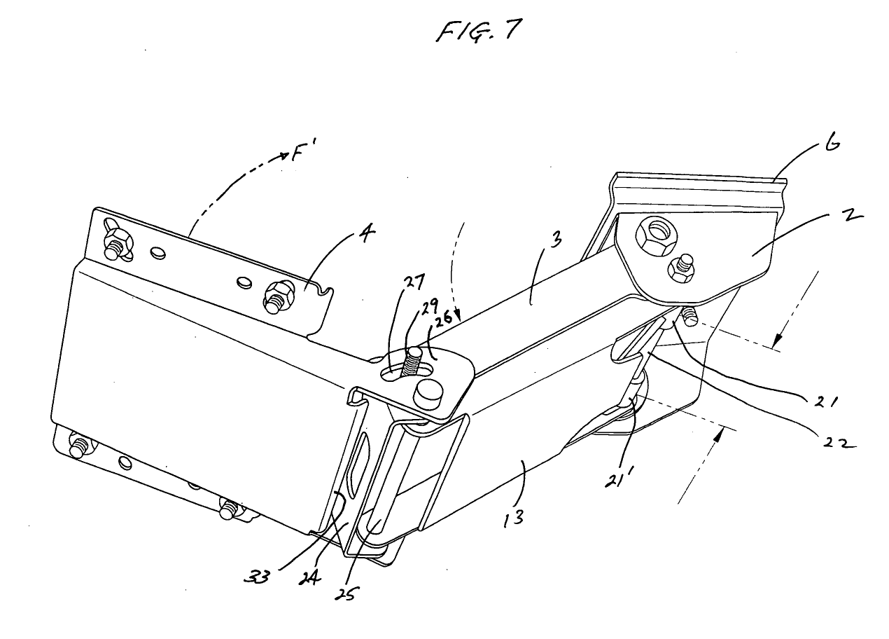

The unlocking features of this invention are illustrated in FIGS. 6 and 7. FIG. 6 represents the initial stage of unlocking the carriage member 3, housing 2 and spreader member from being in locked rotational relationship. As can be seen in FIG. 6, the force F¹ is applied in a clockwise direction to support platform 4 which supports keyboard 32 (keyboard 32 shown in phantom). Support platform 4 pivots initially about second spreader pin 25 and is permitted to do so because arcuate grooves 27 and 27¹ being in slidable relationship with locking pin 29. Pivoting occurs about second spreader pin 25 until lip portion 33 engages translation member 24. Continued application of a clockwise external force thereafter, as shown in FIG. 7, will result in rotation of support platform 4 in a clockwise direction about locking pin 29. A torque will consequently be applied to second spreader pin 22 resulting in axial displacement of spreader member 13 in a direction opposite to the locking direction. The axial movement of spreader member 13 will cause hinge members 31 and 31¹ to be retracted. Hinge members 31 and 31¹ are hinged to both spreader member 13 and to clutch members 21 and 21¹; the clutch members are slidably and telescopically carried by spreader member 22. Consequently, the axial displacement of spreader member 13 induced by the clockwise torque about locking pin 29 withdraws clutch members 21 and 21¹ from bearing engagement with flanges 19 and 19¹ of spreader member 13. The bearing stress transmitted to the housing 2 and carriage member is therefore relieved and the carriage member unlocked from the housing and thus permitted to rotate with respect to housing to a selected angular position. Although not shown in the drawings, a threaded fastener is threadably carried by locking pin 29 which may be tightened so as to bear against platform flange 26 to frictionally lock support platform 4 and carriage member 3 in locked rotational relationship at a pre selected attitude. Thus, the cantilevered locking mechanism of this invention permits the carriage member 3 to be selectively positioned with respect to housing 2 and also permits support platform 4 to be selectively positioned with respect to the carriage member.

A user of the mechanism of this invention may therefore, if the carriage member 3 and housing 2 are in locked rotational relationship, wish to adjust the vertical separation of the keyboard attached to support platform 4 from desk 7. By applying an external force in a clockwise direction, as shown in FIGS. 6 and 7, the support platform will pivot with respect to second spreader pin 25 until lip platform 33 of the support platform bears compressively against translation member 24. Continued application of the external force in a clockwise direction results in torque about locking pin 29 which causes the withdrawal or axial displacement of spreader member 13. Hinge members 31 and 31¹ which are hinged to both spreader member 13 and clutch members 21 and 21¹ will also be withdrawn axially thereby inducing clutch members to slide away from bearing contact with flanged end 19 and 19¹ of the spreader member 13. This releases the bearing stress against the carriage member and housing and consequently unlocks the rotational lock permitting the carriage member 3 to be selectively positioned with respect to housing 2. After the carriage member is positioned, a counterclockwise force, as shown in FIGS. 1 and 2, applied to support platform 4 will pivot the support platform about second spreader pin 25 until barrier ends 28 and 28¹ engage locking pin 29; continued application of the counterclockwise force will cause the spreader member 13 to be axially displaced and the axial displacement will be translated into lateral bearing stress applied to flanged ends 19 and 19¹ thereby frictionally locking the carriage member and housing in fixed rotational relationship. To adjust the attitude of support platform, the threaded fastener (not shown) threadably attached to locking pin 29 may be tightened to bear against platform flange 26 to frictionally lock support platform 4 to carriage member 3.

While I have shown and described an embodiment of this invention, it is to be understood the invention is subject to many modifications without departing from the scope and spirit of the claims recited herein:

What is claimed is:

1. A cantilever adjustable lock mechanism, comprising:
(a) a housing having a longitudinal axis and an axially extending void region therein;
(b) a carriage member having an axis of elongation directionally aligned with said longitudinal axis, said carriage member having a first end and a second end where said first end extends at least in part in said void region and is so carried in rotational relationship with said housing such that upon sufficient lateral bearing stress applied to said carriage member said carriage member and said housing may be in locked rotational relationship;
(c) a spreader pin carried by said housing and extending laterally within said first end of said carriage member, where said first end has an arcuate slot so constructed and adapted to permit slidable passage of said spreader pin therethrough such that said carriage member may pivot with respect to said housing;
(d) a spreader member carried in slidable relationship with said carriage member and having a central axis directionally aligned with said axis of elongation, said spreader member having an axially extending slot where said spreader pin extends through said axially extending slot to permit relative axial displacement of said spreader member with respect to said spreader pin;
(e) a clutch member carried in slidable and telescopic relationship with said spreader pin for applying releasable bearing stress to said first end of said carriage member such that said housing and said carriage member may be selectively locked and unlocked in rotational relationship;
(f) hinge means associated with said spreader member and said clutch member responsive to slidable axial displacement of said spreader member for urging said clutch member into releasable bearing engagement with said spreader member;
(g) a second spreader pin carried by said spreader member and extending laterally therethrough where said second spreader pin is located adjacent said second end of said carriage member and substantially parallel to said spreader pin;
(h) a support platform pivotally carried by said second spreader pin;
(i) a locking pin carried by said carriage member adjacent said second end of said carriage member and extending laterally therethrough where said second spreader pin is substantially parallel to said locking pin and where said support platform has an arcuate groove having a barrier end, said locking pin extending through said arcuate groove and in slidable relationship therewith to permit said support platform upon application of an external force thereto to rotate with respect to said second spreader pin until said locking pin is in bearing engagement with said barrier end of said arcuate groove and thereafter said support member upon continued application of said external force will rotate with respect to said locking pin thereby translating said rotation into axial displacement of said spreader member and locking said carriage member and said housing in locked rotational relationship; and
(j) translation means mounted to said second spreader pin and said locking pin responsive to external force applied thereto by said support platform for translating rotation of said support platform into axial displacement of said spreader member to unlock said carriage member and said housing.

2. The mechanism recited in claim 1 further comprising fastener means carried by said locking pin for applying a releasable bearing stress to said support platform to rotationally lock and unlock said support platform with respect to said carriage member.

3. The mechanism recited in claim 1 further comprising a pivot pin carried by said housing and said carriage member to permit said carriage member to pivot with respect to said housing.

4. The mechanism recited in claim 3 further comprising fastener means carried by said locking pin for applying a releasable bearing stress to said support platform to rotationally lock and unlock said support platform with respect to said carriage member.

5. The mechanism recited in claim 3 further comprising bias means associated with said housing and said carriage member for urging said carriage member to an equilibrium position after displacement therefrom.

6. The mechanism recited in claim 5 further comprising fastener means carried by said locking pin for applying a releasable bearing stress to said support platform to rotationally lock and unlock said support platform with respect to said carriage member.

7. A cantilever adjustable lock mechanism, comprising:
a) a housing having a longitudinal axis and an axially extending void region therein;
(b) a carriage member having an axis of elongation directionally aligned with said longitudinal axis, said carriage member having a first end and a second end where said first end extends at least in part in said void region and is so carried in rotational relationship with said housing such that upon sufficient lateral bearing stress applied to said carriage member said carriage member and said housing may be in locked rotational relationship;
(c) a spreader pin carried by said housing and extending laterally within said first end of said carriage member, where said first end has an arcuate slot so constructed and adapted to permit slidable passage of said spreader pin therethrough such that said carriage member may pivot with respect to said housing;
(d) a spreader member carried in slidable relationship with said carriage member and having a central axis directionally aligned with said axis of elongation, and said longitudinal axis, said spreader member having an axially extending slot where said spreader pin extends through said axially extending slot to permit relative axial displacement of said spreader member with respect to said spreader pin;
(e) clutch means responsive to axial displacement of said spreader member associated with said spreader pin and said spreader member for applying releasable bearing stress to first said end of said carriage member such that said housing and said carriage member may be selectively locked and unlocked in rotational relationship;
(f) a second spreader pin carried by said spreader member and extending laterally therethrough where said second spreader pin is located adjacent said second end of said carriage member and substantially parallel to said spreader pin;
(g) a support platform pivotally carried by said second spreader pin;
(h) a locking pin carried by said carriage member adjacent said second end of said carriage member and extending laterally therethrough where said second spreader pin is substantially parallel to said locking pin and where said support platform has an arcuate groove having a barrier end, said locking pin extending through said arcuate groove and in slidable relationship therewith to permit said support platform upon application of an external force thereto to rotate with respect to said second spreader pin until said locking pin is in bearing engagement with said barrier end of said arcuate groove and thereafter said support member upon continued application of said external force will rotate with respect to said locking pin thereby translating said rotation into axial displacement of said spreader member and locking said carriage member and said housing in locked rotational relationship; and
(i) translation means mounted to said second spreader pin and said locking pin responsive to external force applied thereto by said support platform for translating rotation of said support platform into axial displacement of said spreader member to unlock said carriage member and said housing.

8. The mechanism recited in claim 7 further comprising fastener means carried by said locking pin for applying a releasable bearing stress to said support platform to rotationally lock and unlock said support platform with respect to said carriage member.

9. The mechanism recited in claim 7 further comprising a pivot pin carried by said housing and said carriage member to permit said carriage member to pivot with respect to said housing.

10. The mechanism recited in claim 9 further comprising fastener means carried by said locking pin for applying a releasable bearing stress to said support platform to rotationally lock and unlock said support platform with respect to said carriage member.

11. The mechanism recited in claim 9 further comprising bias means associated with said housing and said carriage member for urging said carriage member to an equilibrium position after displacement therefrom.

12. The mechanism recited in claim 11 further comprising fastener means carried by said locking pin for applying a releasable bearing stress to said support platform to rotationally lock and unlock said support platform with respect to said carriage member.

13. A cantilever adjustable lock mechanism, comprising:
a) a housing having a longitudinal axis and an axially extending void region therein;
(b) a carriage member having an axis of elongation directionally aligned with said longitudinal axis, said carriage member having a first end and a second end where said first end extends at least in part in said void region and is so carried in rotational relationship with said housing such that upon sufficient lateral bearing stress applied to said carriage member said carriage member and said housing may be in locked rotational relationship;
(c) a spreader pin carried by said housing and extending laterally within said first end of said carriage member, where said first end has an arcuate slot so constructed and adapted to permit slidable passage of said spreader pin therethrough such that said carriage member may pivot with respect to said housing;
(d) a spreader member carried in slidable relationship with said carriage member and having a central axis directionally aligned with said axis of elongation, and said longitudinal axis, said spreader member having an axially extending slot where said spreader pin extends through said axially extending slot to permit relative axial displacement of said spreader member with respect to said spreader pin;
(e) clutch means responsive to axial displacement of said spreader member associated with said spreader pin and said spreader member for applying releasable bearing stress to first said end of said carriage member such that said housing and said carriage member may be selectively locked and unlocked in rotational relationship;
(f) a second spreader pin carried by said spreader member and extending laterally therethrough where said second spreader pin is located adjacent said second end of said carriage member and substantially parallel to said spreader pin;
(g) a support platform pivotally carried by said second spreader pin;
(h) releasable locking means associated with said support platform and said carriage member for translating rotation of said support platform in a direction into axial displacement of said spreader member to lock said carriage member and said housing in locked rotational relationship and in the opposite direction to unlock said carriage member and said housing.

14. The mechanism recited in claim 13 further comprising fastener means carried by said locking pin for applying a releasable bearing stress to said support platform to rotationally lock and unlock said support platform with respect to said carriage member.

15. The mechanism recited in claim 13 further comprising a pivot pin carried by said housing and said carriage member to permit said carriage member to pivot with respect to said housing.

16. The mechanism recited in claim 15 further comprising fastener means carried by said locking pin for applying a releasable bearing stress to said support platform to rotationally lock and unlock said support platform with respect to said carriage member.

17. The mechanism recited in claim 15 further comprising bias means associated with said housing and said carriage member for urging said carriage member to an equilibrium position after displacement therefrom.

18. The mechanism recited in claim 13 where said releasable locking means comprises a locking pin carried by said carriage member adjacent said second end of said carriage member and extending laterally therethrough where said second spreader pin is substantially parallel to said locking pin and where said support platform has an arcuate groove having a barrier end, said locking pin extending through said arcuate groove and in slidable relationship therewith to permit said support platform upon application of an external force thereto to rotate with respect to said second spreader pin until said locking pin is in bearing engagement with said barrier end of said arcuate groove and thereafter said support member upon continued application of said external force will rotate with respect to said locking pin thereby translating said rotation into axial displacement of said spreader member and locking said carriage member and said housing in locked rotational relationship and translation means mounted to said second spreader pin and said locking pin responsive to external force applied thereto by said support platform for translating rotation of said support platform into axial displacement of said spreader member to unlock said carriage member and said housing.
